(19) United States
(12) Patent Application Publication
(10) Pub. No.: US 2008/0201295 A1
(43) Pub. Date: Aug. 21, 2008

(54) CACHING PLANS WITH USING DATA VALUES

(76) Inventors: Mylavarapu Praveena, Secunderabad (IN); Bhashyam Ramesh, Secunderabad (IN)

Correspondence Address: JAMES M. STOVER;TERADATA CORPORATION, 2835 MIAMI VILLAGE DRIVE, MIAMISBURG, OH, 45342, US

(21) Appl. No.: 11/677,096

(22) Filed: Feb. 21, 2007

(51) Int. Cl. G06F 17/30

(52) U.S. Cl. 707/2; 707/E17.136

(57) ABSTRACT

A method of selecting for use a stored execution plan for a dynamic SQL query within a database system. Respective selectivity values are maintained that are associated with one or more predicates in the dynamic SQL query for respective historical data values. Respective confidence level values are maintained that are associated with one or more of the selectivity values. One or more data values are received with which to execute the dynamic SQL query. Respective selectivity values are calculated for one or more of the predicates in the dynamic SQL query for the received data value(s). The stored selectivity values are compared with respective corresponding calculated selectivity values. A stored execution plan is selected for use on detecting substantial equality between the respective pairs of compared values.

### BACKGROUND

Typical database systems receive queries to retrieve information from data sources managed by the database system. In a relational database system these data sources are typically organized into a series of tables. Queries are received in a standard format such as SQL.

Most databases use an optimizer that attempts to generate an optimal query execution plan. When a query is issued with a USING statement the optimizer in most cases ignores the data values associated with the USING statement. The optimizer assumes default selectivity and produces a generic conservative plan. Because it is a generic plan it is cached and is reused from the cache even for different data values associated with the USING statement.

There are many problems with such generic plans. Most of these problems result in sub optimal plans. For example, access tends to be a full file scan instead of indexed access. Another problem is that joins tend to be a sort merge instead of a nested loop.

If the optimizer were to take into consideration data values associated with a USING statement in a query then the optimizer can generate more aggressive and optimal plans for the query. The issue with taking data values associated with a USING statement in plan generation is that the same plan cannot be reused unless the query is reissued with the same exact data values associated with the USING statement. Therefore there is little point in the caching of such plans.

### SUMMARY

Described below is a method of selecting for use a stored execution plan for a dynamic SQL query within a database system. Respective selectivity values are maintained that are associated with one or more predicates in the dynamic SQL query for respective historical data values. Respective confidence level values are maintained that are associated with one or more of the selectivity values. One or more data values are received with which to execute the dynamic SQL query. Respective selectivity values are calculated for one or more of the predicates in the dynamic SQL query for the received data value(s). The stored selectivity values are compared with respective corresponding calculated selectivity values. A stored execution plan is selected for use on detecting substantial equality between the respective pairs of compared values.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flowchart of the parser of FIG. 2.

FIG. 4 is an example table on which the techniques described below can be applied.

FIG. 5 shows an example of statistics collected on one of the columns of the table of FIG. 4.

### DETAILED DESCRIPTION

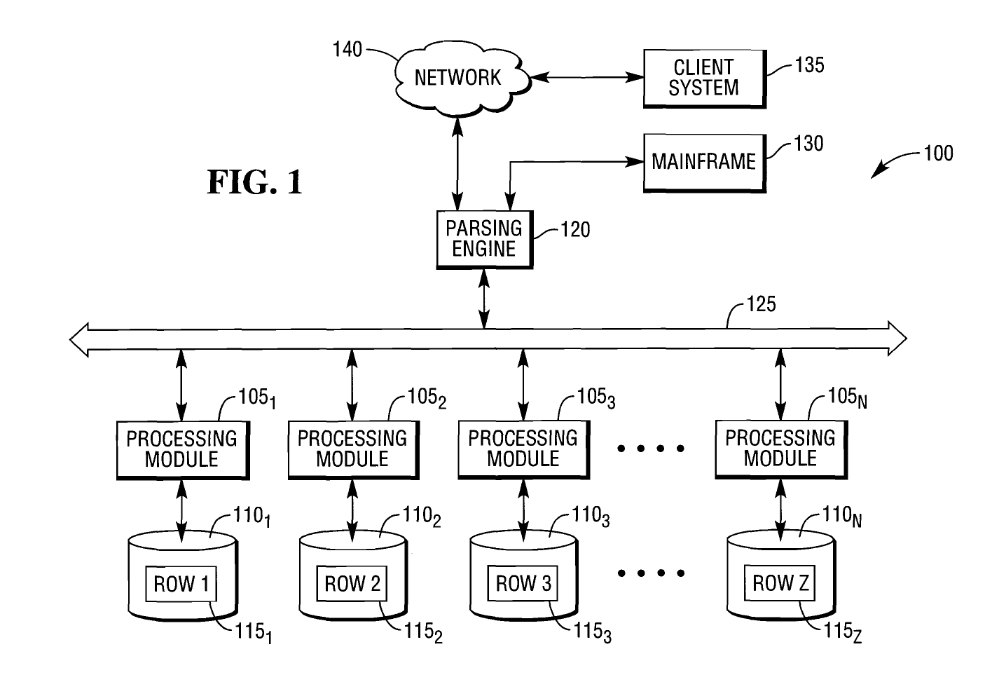

FIG. 1 shows an example of a database system 100, such as a Teradata active data warehousing system available from NCR Corporation. Database system 100 is an example of one type of computer system in which the techniques that deal with plans having using data values are implemented. In computer system 100, vast amounts of data are stored on many disk-storage-facilities that are managed by many processing units. In this example, the data warehouse 100 includes a relational database management system (RDBMS) built upon a massively parallel processing (MPP) platform.

Other types of database systems, such as object-relational database management systems (ORDMS) or those built on symmetric multi-processing (SMP) platforms are also suited for use here.

The data warehouse 100 includes one or more processing modules 105_{1 . . . N} that managed the storage and retrieval of data and data storage facilities 110_{1 . . . N}. Each of the processing modules 105_{1 . . . N} manages a portion of a database that is stored in a corresponding one of the data-storage facilities 110_{1 . . . N}. Each of the data-storage facilities 110_{1 . . . N} includes one or more disk drives.

The system stores data in one or more tables in the data-storage facilities 1101 . . . N. The rows 115_{1 . . . Z} of the tables are stored across multiple data-storage facilities 110_{1 . . . N} to ensure that the system workload is distributed evenly across the processing modules 105_{1 . . . N}. A parsing engine 120 organizes the storage of data and the distribution of table rows 115_{1 . . . Z} among the processing modules 105_{1 . . . N}. The parsing engine 120 also coordinates the retrieval of data from the data-storage facilities 110_{1 . . . N} over network 125 in response to queries received from a user at a mainframe 130 or a client computer 135 connected to a network 140. The database system usually receives queries and commands to build tables in a standard format, such as SQL.

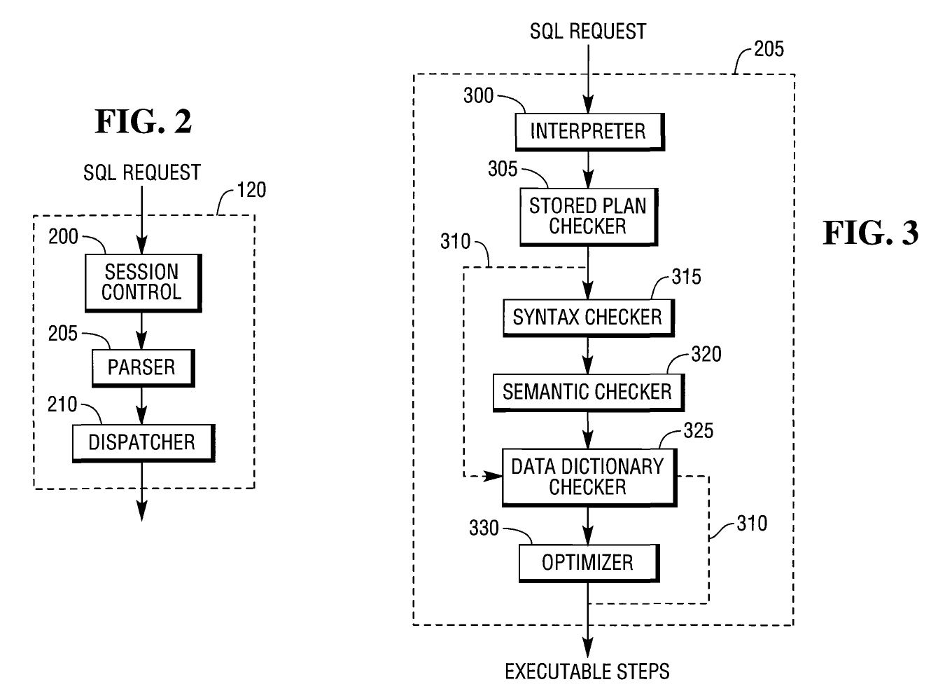

FIG. 2 shows one example system in which the parsing engine 120 is made up of three components: a session control 200, a parser 205 and a dispatcher 210. The session control 200 provides a log on and log off function. It accepts a request for authorization to access the database, verifies it, and then either allows or disallows the access.

Once the session control 200 allows a session to begin, a user may submit an SQL request, which is routed to the parser 205. As illustrated in FIG. 3, the parser 205 interprets the SQL request (block 300). Stored or previously compiled execution plans are typically saved in a plan cache and optionally stored in a data dictionary on disk for subsequent executions of the same queries. If a given query is assigned a unique name then repeated instances of the same query can be easily identified using this name. If not, the system will perform a text based comparison on the SQL to identify duplicate instances of queries. A stored plan checker 305 looks to see if a plan already exists for the specified SQL request in the plan cache, or in the dictionary if not found in the plan cache.

If an existing plan is found by the stored plan checker 305 then some of the following steps can be skipped as indicated by alternate path 310.

The parser checks the request for proper SQL syntax (block 315), evaluates it semantically (block 320) and consults a data dictionary to ensure that all of the objects specified in the SQL request actually exist and the user has the authority to perform the request (block 325). Finally, the parser 205 runs an optimizer (block 330) that develops the least expensive plan to perform the request.

The query processing architecture described above for most relational database systems is divided into a compile time sub-system 120, 205, to parse and optimize the SQL request and a separate run time sub-system implemented by processing modules 105_{1 . . . N} to interpret the plan and execute the query.

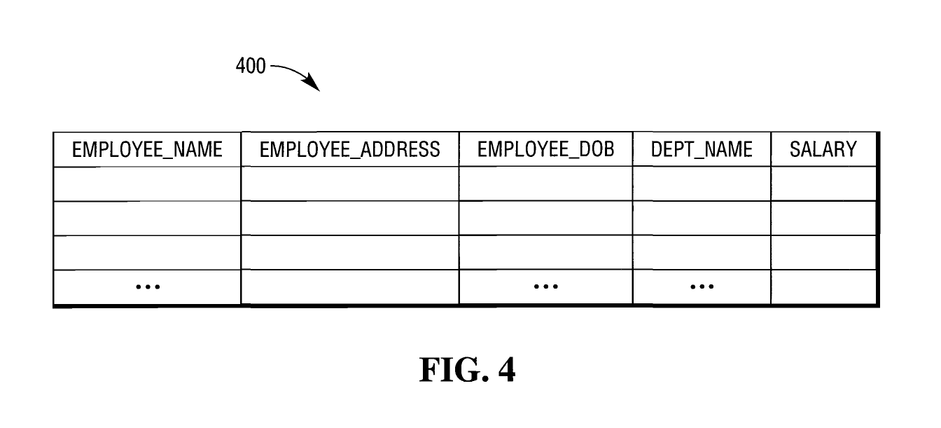

FIG. 4 illustrates a typical table 400 that is stored in system 100. Table 400 is an employee table (emp). Typical fields in the table include employee_name, employee_dob, dept_name and salary. Other typical fields include employee address. It will be appreciated that although employee-address is shown as a single column the address would in fact be represented by several fields such as street name and number, suburb, city, state, zip code and country.

Set out below is a typical query that could be used to interrogate table 400.

SELECT employee_name, salary FROM emp
WHERE dept_name= ‘Software Development’

The above SQL statement is known as a static SQL statement. The full text of this statement is known at compile time and the statement does not change from execution to execution.

The above static query can be rewritten as a USING query. The advantage of a USING query is that the search term dept_name is not hard coded but any department can be issued at run time. The query is able to search for dept_name values other than ‘Software Development’.

The following sets out a USING query. The USING variable can be used with different values when the query is issued. For example the USING value can be bound to ‘Software Development’ for one query and to ‘Human Resources’ for another query.

```
USING (x varchar (20))
    SELECT employee-name, salary FROM emp
    WHERE dept_name = :x;
```

In some types of SQL statements, known as dynamic SQL statements, the full text of the statement is unknown until run time. Such statements can and probably will change from execution to execution.

A dynamic SQL feature is a technique for generating and executing SQL commands dynamically at run time. Dynamic SQL queries are prepared at program execution time, not compilation time. This means that the application program compiler cannot check for errors at compilation time. It also means that programs can create specialized queries in response to user or other input. Some programs must build and process SQL statements where some information is not known in advance. A reporting application might build different SELECT statements for the reports it generates, substituting new table and column names and ordering or grouping by different columns. Such statements are called dynamic SQL statements.

In a dynamic SQL statement the column names for example may not be known at application program compile time. Depending on the user request the column of interest would be determined and the query built in a piecemeal fashion by the application based on user input and based perhaps on analysis and even database accesses.

Dynamic SQL statements contain place holders for bind arguments. Where an SQL statement includes several bind arguments, all bind arguments can be placed in the SQL statement with a using clause.

```
USING (x varchar (20), y varchar (15))
    SELECT :y FROM emp
    WHERE dept_name = :x;
```

The optimizer 300 described above has access to statistics previously requested by the user to be collected on one or more of the tables stored on data-storage facilities 110.

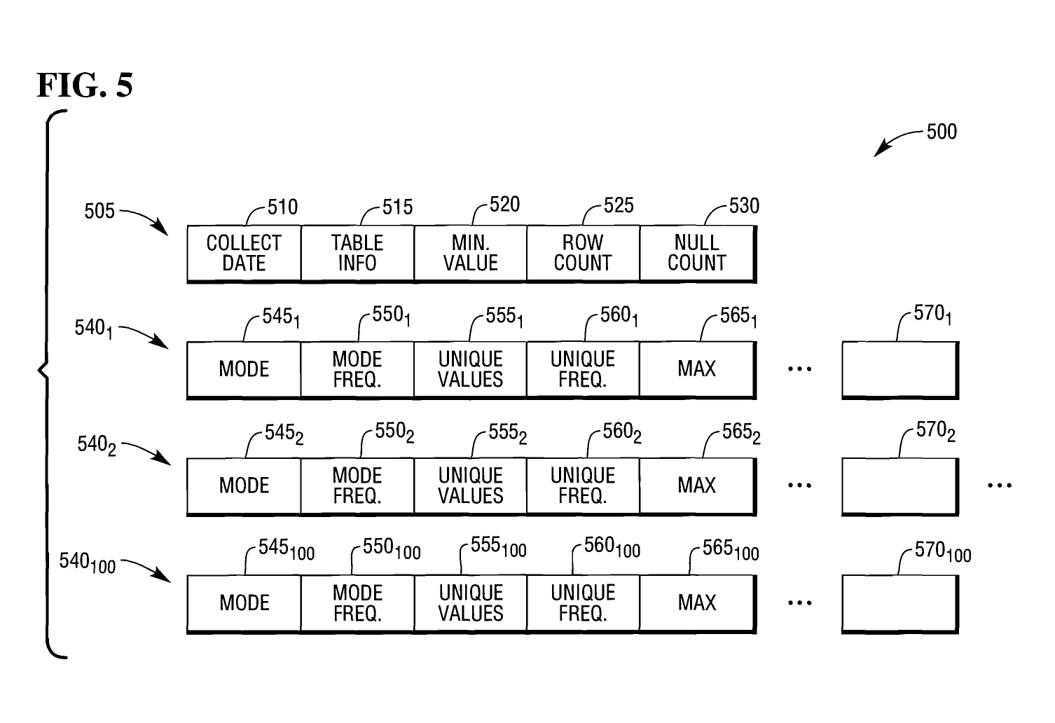

FIG. 5 shows an example of statistics 500 collected on one of the columns of table 400 of FIG. 4. The rows in the table have first been sorted by the column on which the statistics have been generated. The minimum value is recorded in the statistics. The rows are then grouped into a plurality of ordered intervals based on the date-time stamp value in each row. Typically, there are 100 groups or intervals in each group and each group or interval has approximately the same number of rows. Various statistics are calculated, for example the mode of each interval representing the date-time stamp value that occurs most frequently within an interval.

Statistics 500 are typically stored in a data dictionary. The statistics include an initial interval 505 that is also referred to as interval zero. Interval zero includes basic or general information about the table and includes, for example, a collection date 510 representing the date the statistics were collected, general table information 515, a minimum value 520 representing the smallest value in the column of table 400, a row count 525 representing the total count or number of rows in the table, and a null count 530 representing the total number of null values in the table.

Following interval zero is data representing each of the 100 intervals, indicated as 540₁, 540₂ and so on to 540₁₀₀. Each interval 540_{1 . . . 100} in turn includes the mode value 545_{1 . . . 100} representing the most frequently occurring value in that interval and the number or frequency 550_{1 . . . 100} of those occurrences, the number of other unique values 555_{1 . . . 100} in that interval, the total number 560_{1 . . . 100} of those occurrences and the maximum value 565_{1 . . . 100} representing the highest value in that interval. It will be appreciated that the statistics 500 in some circumstances include other statistical data 570_{1 . . . 100} depending on the purpose for which the statistics are collected.

The minimum, maximum and distribution of values are used to compute the selectivity of a value. The optimizer can then use the selectivity of values when it determines query cost estimates. Selectivity is an estimate of the percentage of rows that will be returned by a filter in a query. Selectivity values typically range from 0.0 to 1.0, where 0.0 indicates a very selective filter that passes very few rows and 1.0 indicates a filter that passes almost all rows. The optimizer uses selectivity information to reorder expressions in the query predicate so that filters that are expensive to call given the values of their arguments are evaluated after filters that are inexpensive to call. One example in a query is whether to perform a join first or an aggregation first. Therefore the optimizer reduces the number of comparisons and improves performance.

When a dynamic SQL statement having a using clause is received, it is necessary to determine whether or not the plan generated with the using data values can be reused. If it is determined that the plan can be reused, it is sensible for the system to cache the plan. Otherwise it is not sensible to cache the plan. A cached plan must therefore include a plurality of pass-fail criteria besides just the execution plan.

The data values to be inserted into the dynamic SQL query with the using statement have a data parcel size. One technique involves examining the data parcel size. Once the using data values are bound in the dynamic query, the query will have a certain length known as a data parcel size. A previously stored plan would have been generated with one set of using data values. The new set of using data values are bound into the dynamic query and the length of the bound query is compared with the previously bound length and type of value of the cached plan. If the data size is the same or very similar, this is one indicator that the new using data values could be similar to the old using data values and the cached plan may be reused for executing the dynamic query. One problem with solely relying on this comparison is that there can be a lot of selectivity variation given a small variation in data parcel size.

Another technique is to determine the extent to which a using value is going to affect a stored plan. In other words this involves determining the sensitivity of a stored plan to changes in using values. This can be estimated by the selectivity of each predicate along with its confidence level. As described above, the selectivity of a predicate is an estimate of the percentage of rows that will be returned by a predicate in a query. The confidence level is an indicator of the number of rows that the statistics compiler has scanned when compiling the statistics. A high confidence level value indicates that a high number of rows of the database have been scanned.

If the selectivity of every using predicate has no confidence associated with it then this will lead to conservative plans. Conservative plans will not actively filter results during query execution and will return a larger percentage of rows of the table as results. Such plans can be reused for other using data values also.

If the selectivity of each predicate has low confidence then this means that a small number of rows have been scanned in order to estimate the selectivity of the predicates. In this case the data parcel size described above as well as a selectivity sensitivity threshold explained below can be used to determine whether the plan can be reused.

If the confidence level of each predicate in the cached plan is high then the selectivity with the new using data values should be calculated and if each of the respective calculated selectivity values are the same as the cached selectivity values then the plan can be reused.

As an alternative to testing for strict equality of selectivity values, this criteria can be relaxed by using a threshold. When an original plan is generated, each of the selectivity values generated with high confidence can be annotated with the extent to which it impacts the plan. In other words it is possible to store along with each selectivity value a threshold value within which the generated plan does not change. This threshold can be used when a calculated selectivity is compared with a cached selectivity. This is known as a selectivity sensitivity threshold.

A sensitivity threshold could specify for example that calculated selectivity values of between 10 and 50 mean that the plan can be reused. Calculated selectivity values of lower than 10 or greater than 50 mean that the plan cannot be reused and a different plan should be used.

The selectivity sensitivity thresholds can be determined by experiment by executing the dynamic query with different using values. The particular plan that is executed given the varying using values can be used to determine the selectivity sensitivity threshold.

Some database systems use partitions. A further test to determine whether or not a cached plan can be reused is to calculate the number of partitions scanned. If it is determined that two high confidence selectivity predicates can result in differing numbers of partitions being statically eliminated then the partition ranges that are eliminated can also be stored.

The text above describes one or more specific embodiments of a broader invention. The invention also is carried out in a variety of alternative embodiments and thus is not limited to those described here. Those other embodiments are also within the scope of the following claims.

We claim:

1. A method of selecting for use a stored or previously compiled execution plan for a dynamic SQL query within a database system, the method comprising:
maintaining respective selectivity values associated with one or more predicates in the dynamic SQL query for respective historical data values;
maintaining respective confidence level values associated with one or more of the selectivity values;
receiving one or more data values with which to execute the dynamic SQL query, calculating respective selectivity values for one or more of the predicates in the dynamic SQL query for the received data value(s);
comparing the stored selectivity values with respective corresponding calculated selectivity values; and
selecting for use the stored execution plan on detecting substantial equality between the respective pairs of compared values.

2. The method of claim 1 wherein the confidence level associated with at least one of the stored selectivity values is relatively high.

3. The method of claim 2 wherein the stored and calculated selectivity values are numerical values in the range 0.0 to 1.0.

4. The method of claim 3 further comprising the steps of maintaining respective selectivity tolerance values associated with one or more of the selectivity values; and
selecting for use the stored execution plan on detecting respective differences between the respective pairs of compared values that are less than the respective corresponding selectivity tolerance values.

5. The method of claim 1 wherein the confidence level associated with at least one of the stored selectivity values is relatively low.

6. The method of claim 5 wherein the stored and calculated selectivity values are numerical values in the range 0.0 to 1.0.

7. The method of claim 6 further comprising the steps of:
maintaining respective selectivity tolerance values associated with one or more of the selectivity values;
maintaining a data size value associated with the dynamic SQL query for respective historical data values;
calculating a data size value for the dynamic SQL query for the received data value(s); and
selecting for use the stored execution plan on detecting respective differences between the respective pairs of compared values that are less than the respective corresponding selectivity tolerance values and on detecting substantial equality between the stored data size value and the calculated data size value.
